(19) United States
(12) Patent Application Publication
(10) Pub. No.: US 2023/0385698 A1
(43) Pub. Date: Nov. 30, 2023

(54) GENERATING TRAINING DATA FOR VISION SYSTEMS DETECTING MOVING OBJECTS

(71) Applicant: Tesla, Inc., Austin, TX (US)

(72) Inventors: James Anthony Musk, San Francisco, CA (US); Dhaval Shroff, San Francisco, CA (US); Pengfei Phil Duan, Newark, CA (US)

(21) Appl. No.: 18/320,776

(22) Filed: May 19, 2023

Related U.S. Application Data
(60) Provisional application No. 63/365,121, filed on May 20, 2022.
(60) Provisional application No. 63/365,078, filed on May 20, 2022.

(51) Int. Cl. G06N 20/00; B60W 60/00

(52) U.S. Cl. CPC G06N 20/00; B60W 2420/42; B60W 2554/00; B60W 60/001

(57) ABSTRACT

Systems and methods for training machine learning models utilized for autonomous driving. An example method includes obtaining a set of data corresponding to the operation of a vehicle, wherein the set of data includes a first set of data corresponding to the operation of a vision-based detection system and a second set of data corresponding to the operation of a non-vision-based detection system, wherein the first and second set of data corresponding to a common timestamp; processing the first set of data to correspond to a common format for detection; processing the second set of data to correspond to the common format for detection; combining the processed first set of data and the processed second set of data to form a common set of data; processing the combined set of data; and training a machine learning model for vision-based detection system based on the processing combined set of data.

### CROSS-REFERENCE TO RELATED APPLICATION

This application claims priority to U.S. Provisional Patent Application No. 63/365,121 titled “GENERATING TRAINING DATA FOR VISION SYSTEMS DETECTING MOVING OBJECTS” and filed on May 20, 2022, the disclosure of which is hereby incorporated herein by reference in its entirety. This application claims priority to U.S. Provisional Patent Application No. 63/365,078 titled “VISION-BASED MACHINE LEARNING MODEL FOR AUTONOMOUS DRIVING WITH ADJUSTABLE VIRTUAL CAMERA” and filed on May 20, 2022, the disclosure of which is hereby incorporated herein by reference in its entirety.

### BACKGROUND

### Technical Field

The present disclosure relates to machine learning models, and more particularly, to train the machine learning models with processed data.

### Description of Related Art

Generally described, computing devices and communication networks can be utilized to exchange data and/or information. In a common application, a computing device can request content from another computing device via the communication network. For example, a computing device can collect various data and utilize a software application to exchange content with a server computing device via the network (e.g., the Internet).

Generally described, a variety of vehicles, such as electric vehicles, combustion engine vehicles, hybrid vehicles, etc., can be configured with various sensors and components to facilitate the operation of the vehicle or management of one or more systems included in the vehicle. In certain scenarios, a vehicle owner or vehicle user may wish to utilize sensor-based systems to facilitate the operation of the vehicle. For example, vehicles can often include hardware and software functionality that facilitates location services or can access computing devices that provide location services. In another example, vehicles can also include navigation systems or access navigation components that can generate information related to navigational or directional information provided to vehicle occupants and users. In still further examples, vehicles can include vision systems to facilitate navigational and location services, safety services or other operational services/components.

### BRIEF DESCRIPTION OF THE DRAWINGS

FIG. 1 is a diagram illustrating an example of an interactive environment of example embodiments.

FIG. 2A is a block diagram illustrating example elements included in a vehicle.

FIG. 2B is a block diagram illustrating an example autonomous or semi-autonomous vehicle, which includes a multitude of image sensors an example processor system.

FIG. 2C is a block diagram illustrating the example processor system determining static information based on received image information from the example image sensors.

FIG. 3 is an example architecture of vision information processing component.

FIG. 4A is a diagram illustrating an example of embodiment for training machined learning models.

FIG. 4B is a diagram illustrating an example of embodiment for transmitting trained machined learning models to vehicles.

FIG. 5 is a flow diagram illustrating an example of embodiment for training machined learning models.

### DETAILED DESCRIPTION

Generally described, one or more aspects of the present disclosure relate to the configuration and implementation of vision systems in autonomous or semi-autonomous vehicles. By way of illustrative example, aspects of the present application relate to the configuration and training of machine learning models used in vehicles relying solely on vision systems for various operational functions. Illustratively, the vision-only systems are in contrast to vehicles that may combine vision-based systems with one or more additional sensor systems, such as radar-based systems, LIDAR-based systems, SONAR-systems, and the like.

As will be described, a vision-only machine learning model may be opportunistically trained via leveraging a fleet of vehicles which include vision-sensors (e.g., image sensors) and emissive sensors (e.g., radar). For example, the fleet of vehicles may execute two machine learning models which are able to characterize objects positioned about the vehicles. Example objects may include other vehicles, pedestrians, signs, lane lines, and so on. A first of the machine learning models may include a legacy model which relies upon vision-data along with radar data. As may be appreciated, the radar data may be used to inform or determine distances and/or velocities of objects. A second of the machine learning models may include the vision-only machine learning model which only uses vision-data to determine distances and/or velocities of objects.

In some embodiments, distances and/or velocities determined using radar may be used as ground truth data to update the vision-only machine learning model. For example, an outside system may update the parameters of the vision-only machine learning model via error propagation techniques (e.g., gradient descent) based on the ground truth data and the output generated via the vision-only machine learning model. As an example, distances and/or velocities to the same objects determined using both machine learning models may be compared and used to update the vision-only machine learning model. For this example, time stamp information may be used to ensure synchronization between objects detected via both machine learning models.

In this way, the vision-only machine learning model may be rapidly updated using substantial amounts of training data which may be automatically gathered by the fleet of vehicles during normal end-user operation. Newer versions of the vision-only machine learning model may then be transmitted to the fleet, who may continue to gather training data.

The vision-only machine learning model may optionally operate in a shadow mode such that autonomous or semi-autonomous driving is effectuated using the legacy model. In some embodiments, each vehicle in the fleet of vehicles may include a processor system which can execute the vision-only machine learning model and the legacy model at the same time. Thus, both models may identify the same objects positioned about the vehicle. Additionally, both models may characterize the objects such as determining classification (e.g., vehicle, pedestrian, stop sign) and parameters (e.g., distance, velocity, position, direction, rotation, and so on). Using shadow mode may ensure that the legacy model is utilized for autonomous or semi-autonomous driving while the vision-only machine learning model is used to gather training data.

The vision-only machine learning model may advantageously rely upon increased software complexity to enable a reduction in sensor-based hardware complexity while enhancing accuracy. For example, image sensors may be used in some embodiments. Through the use of image sensors, such as cameras, the described model enables a sophisticated simulacrum of human vision-based driving. The vision-only machine learning model may obtain images from the image sensors and combine (e.g., stitch or fuse) the information included therein. For example, the information may be combined into a vector space which is then further processed by the machine learning model to extract objects, signals associated with the objects, and so on.

In accordance with aspects of the present application, a network service can train the vision-only machine learning model in a training dataset. A first portion of the training dataset may correspond to data collected from target vehicles that include vision systems. Additionally, a second portion of the training data may correspond to additional information obtained from other sensor systems, such as radar systems, LIDAR systems, and the like. For purposes of illustration, reference to an “additional detection system” or “other detection system” may be generally interpreted as reference to a non-vision-based detection system that corresponds to the second dataset as discussed herein.

Illustratively, a network service can receive the combined set of inputs (e.g., the first dataset and the second dataset) from one or more target vehicles which include both vision-based detection systems and at least one additional detection system. The network service can then process the vision-based data from the first dataset, such as to complete lost frames of video data and the like. The network service can then generate a trivial version of the first dataset (e.g., vision data) and the second dataset (e.g., data from the non-vision-based detection system) that standardizes the datasets for use in training the vision-only machine learning model. For example, the network service can process the collected first set of data (e.g., vision data) to illustratively generate representations of detected objects in the form of bounding boxes and three-dimensional positions. In another example, the network service can utilize the collected set of second data (e.g., detection system data) to identify a set number of attributes (e.g., position and velocity) for each detected object.

The network service may then combine the data. The combined set of data can result in a set of data which tracks objects during a defined set of time. The network service can then process the combined dataset using various techniques. Such techniques can include smoothing, extrapolation of missing information, applying kinetic models, applying confidence values, and the like.

Thereafter, the network service generates an updated machine learning model based on training using the combined dataset. The trained machine learning model may be transmitted to vision-only based vehicles or to target vehicle with both vision and detection system for repeating the process and further updating/refining the machine learning model.

Prior techniques to generate training data relied upon human-labeled data which limited the extent to which reliable training data may be generated. Additionally, the human-labeled may not be sufficiently large or diverse to enable high accuracy for a resulting machine learning model. With respect to autonomous driving, obtaining reliably accurate distances, velocities, and so on of objects may be a time-intensive process. However, using the techniques described herein, a fleet of vehicles may be used as part of a large-scale automated training data gathering technique. For example, the vehicles may execute two disparate machine learning models which identify and characterize the same objects positioned about the vehicles. This may allow for a dramatic improvement in gathering training data for updating of the vision-only machine learning model described herein. To create effective training data from collected video data, a human would be required to analyze and label individual data frames and provide/verify the appropriate attributes that are used as labels for the training set. Such a manual process is inefficient and adds significant delays in the training of vision-based detection systems. Additionally, reliance on collected vision information for training set data can also propagate errors associated with missing frames of video data, discrepancies in camera data, etc. Accordingly, utilization of collected vision data to form training set data can be inefficient.

To address at least a portion of the above deficiencies, aspects of the present application correspond to the utilization of a combined set of inputs from sensors or sensing systems to generate machine learning model for utilization in vehicles with vision system-only based processing. Aspects of the present application correspond to the utilization of a combined set of inputs from sensors or sensing systems to create updated training sets for use in machine learning models. The combined set of inputs includes a first set of data corresponding to the vision system from a plurality of cameras configured in a vehicle. The combined set of inputs further includes a second set of data corresponding to detection systems (e.g., radar, LIDAR, etc.) also configured in a vehicle.

Illustratively, a network service, implementing one or more machine learning models, can receive the combined set of inputs (e.g., the first dataset and the second dataset) from a target vehicle, including both vision-based detection systems and non-vision-based detection systems (e.g., additional detection system). The network service can then process the information from the first dataset, including the vision-based data, such as to complete lost frames of video data and the like. The network service then generates trivial version of the first dataset (e.g., vision data) and the second dataset (e.g., data from the additional detection system) that formats or otherwise standardizes the data from the first and second datasets for use in machine learning model(s). The network service then combines the data based on standardized data. Illustratively, the combined datasets allow the supplementing of the previously collected vision data with additional information or attribute/characteristics that may not have been otherwise available from initially processing the vision data. The network service can then process the combined data. Specifically, the network service can automatically create larger amounts of trained data based on utilizing the attribute information obtained from the non-video-based detection system as label data for the corresponding, respective video-based detection system. This not only increases the speed of the creation of the training data, but can result in much larger training sets for improved machine learning model performance. Thereafter, the network service generates an updated machine learning model based on training on the combined dataset. The trained machine learning model may be transmitted to vision-only based vehicles or to target vehicles with both vision and detection system for repeating the process and further updating/refining the machine learning model.

In some aspects of this application, the vision-only machine learning model may project objects and roads surrounding a vehicle in a vector space. The projection may be with respect to a virtual camera, such as a camera pointing downwards toward the car in a birds-eye view. Thus, objects positioned about the vehicle are projected into this birds-eye view vector space effectuating the accurate identification of certain types of objects. The description of the birds-eye view is included in U.S. patent application Ser. No. 17/820,849, titled “VISION-BASED MACHINE LEARNING MODEL FOR AGGREGATION OF STATIC OBJECTS AND SYSTEMS FOR AUTONOMOUS DRIVING,” which is hereby incorporated by reference in their entirety and form part of this disclosure as if set forth herein. The projection may also be with respect to a virtual camera being set at a particular height (e.g., 1 meter, 1.5 meters, 2 meters, 10 meters, 20 meters, and so on). In this way, objects may be positioned in a vector space which reduces occlusions but enables a more forward-look at the objects. Example detailed description related to this machine learning model is included in U.S. patent application Ser. No. 17/820,859, titled “VISION-BASED MACHINE LEARNING MODEL FOR AUTONOMOUS DRIVING WITH ADJUSTABLE VIRTUAL CAMERA,” which is hereby incorporated by reference in their entirety and form part of this disclosure as if set forth herein.

Although the various aspects will be described in accordance with illustrative embodiments and a combination of features, one skilled in the relevant art will appreciate that the examples and combination of features are illustrative in nature and should not be construed as limiting. More specifically, aspects of the present application may be applicable with various types of vehicles, including vehicles with different of propulsion systems, such as combination engines, hybrid engines, electric engines, and the like. Still further, aspects of the present application may be applicable with various types of vehicles that can incorporate different types of sensors, sensing systems, navigation systems, or location systems. Accordingly, the illustrative examples should not be construed as limiting. Similarly, aspects of the present application may be combined with or implemented with other types of components that may facilitate the operation of the vehicle, including autonomous driving applications, driver convenience applications and the like.

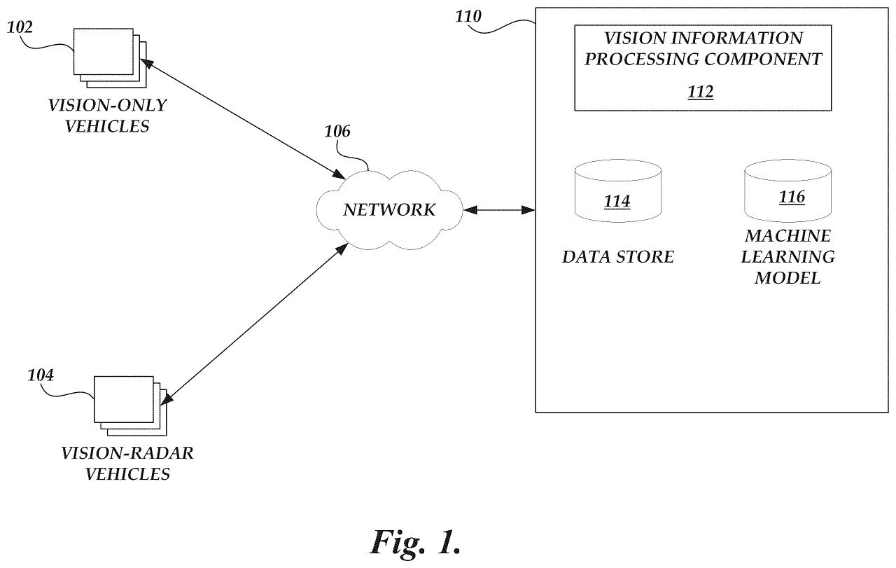

FIG. 1 depicts a block diagram of an embodiment of the system 100. The system 100 can comprise a network, the network connecting a first set of vehicles 102, a second set of vehicles 104, and a network service 110. Illustratively, the various aspects associated with the network service 110 can be implemented as one or more components that are associated with one or more functions or services. The components may correspond to software modules implemented or executed by one or more external computing devices, which may be separate stand-alone external computing devices. Accordingly, the components of the network service 110 should be considered as a logical representation of the service, not requiring any specific implementation on one or more external computing devices.

Network 106, as depicted in FIG. 1, connects the devices and modules of the system. The network can connect any number of devices. In some embodiments, a network service provider provides network-based services to client devices via a network. A network service provider implements network-based services and refers to a large, shared pool of network-accessible computing resources (such as compute, storage, or networking resources, applications, or services), which may be virtualized or bare-metal. The network service provider can provide on-demand network access to a shared pool of configurable computing resources that can be programmatically provisioned and released in response to customer commands. These resources can be dynamically provisioned and reconfigured to adjust to the variable load. The concept of “cloud computing” or “network-based computing” can thus be considered as both the applications delivered as services over the network and the hardware and software in the network service provider that provide those services. In some embodiments, the network may be a content delivery network.

Illustratively, the first set of vehicles 102 corresponds to one or more vehicles configured with vision-only based system for identifying objects and characterizing one or more attributes of the identified objects. The first set of vehicles 102 are configured with machine learning model, such as machine learning model implemented a supervised learning model (e.g., a neural network), that is configured to utilize solely vision systems inputs to identify objects and characterize attributes of the identified objects, such as position, orientation, velocity and acceleration attributes. The first set of vehicles may be configured without any additional detection systems, such as radar detection systems, LIDAR detection systems, and the like. The second set of vehicles 104 are also configured with machine learning model, such as machine learning model implemented a supervised learning model, that are configured to utilize solely vision systems inputs to identify objects and characterize attributes of the identified objects, such as position, velocity, and acceleration attributes. Additionally, the second set of vehicles 104 may be configured without any additional detection systems, such as radar detection systems, LIDAR detection systems, and the like. The second set of vehicles may be considered a target set of vehicles for generating first and second sets of data related to the detection of objects and characteristics such that the first set of data corresponds to vision system data and the second set of data corresponds to other detection system data. As will be described, the first and second datasets from the target vehicles (e.g., the second set of vehicles 104) will be utilized to form additional training data used to train the machine learning model subsequently used by the vision only set of vehicles 102.

Illustratively, the network service 110 can include a plurality of network-based services that can provide functionality responsive to configurations/requests for machine learning model for vision-only based systems as applied to aspects of the present application. As illustrated in FIG. 1, the network-based services 110 can include a vision information processing component 112 that can obtain datasets from target vehicles 104, process sets of data to form training materials for machine learning model, and generate machine learning model for vision-only based vehicles 102. The network-based service can include a plurality of data stores for maintaining various information associated with aspects of the present application, including a target vehicle data store 114 and machine learning model 116. The data stores in FIG. 1 are logical in nature and can be implemented in the network service 110 in a variety of manners. For example, the network service 110 can access additional service providers or computing instances to execute machine learning model or the other processing described herein.

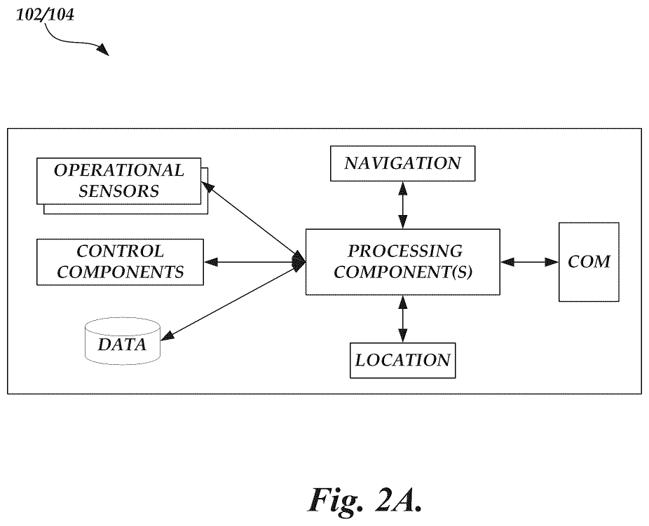

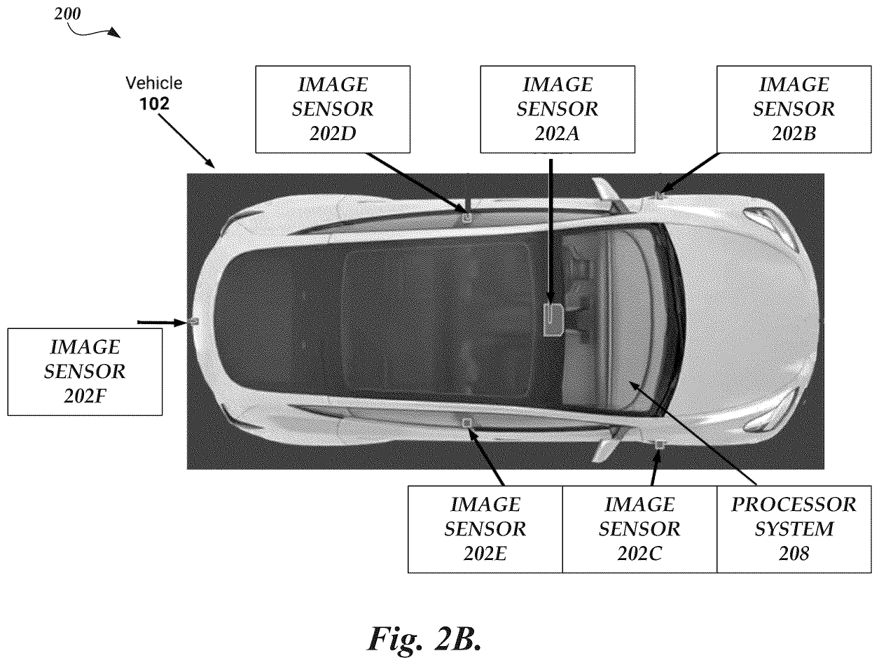

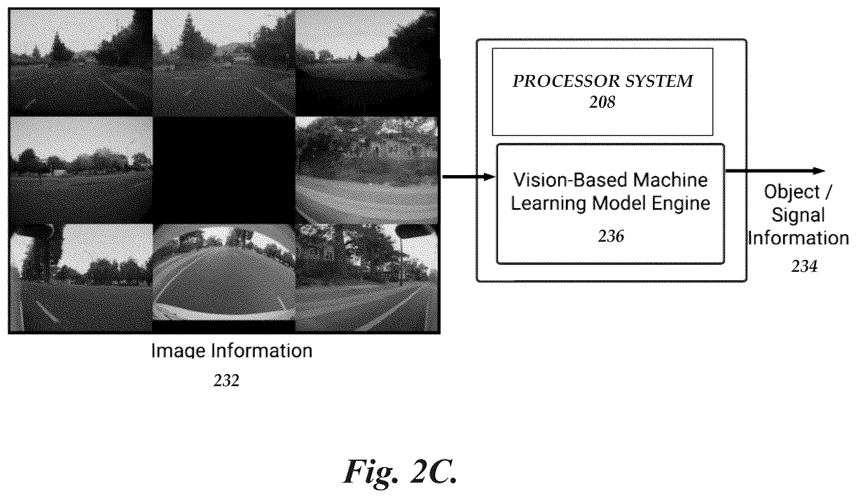

For purposes of illustration, FIG. 2A illustrates an environment that corresponds to vehicles 102 or vehicles 104 in accordance with one or more aspects of the present application. The environment includes a collection of local sensor inputs that can provide inputs for the operation of the vehicle or collection of information as described herein. The collection of local sensors can include one or more sensor or sensor-based systems included with a vehicle or otherwise accessible by a vehicle during operation. The local sensors or sensor systems may be integrated into the vehicle. Alternatively, the local sensors or sensor systems may be provided by interfaces associated with a vehicle, such as physical connections, wireless connections, or a combination thereof.

In one aspect, the local sensors can include vision systems that provide inputs to the vehicle, such as image data that can be used for the detection of objects, attributes of detected objects (e.g., position, velocity, orientation, acceleration, etc.), presence of environment conditions (e.g., snow, rain, ice, fog, smoke, etc.), and the like. An illustrative collection of cameras mounted on a vehicle to form a vision system will be described with regard to FIG. 2B. As previously described, vehicles 102 will rely on such vision systems for defined vehicle operational functions without assistance from or in place of other traditional detection systems (e.g., no alternative detection systems).

In contrast, the local sensors for vehicles 104 can include detection systems, such as radar-based detection systems, LIDAR-based detection systems, and the like, for purpose of detection of objects and determination of a set of attributes. Illustratively, the detection systems and the vision system may work in parallel in vehicles 104 so that the first and second sets of data may be collected as described herein.

In yet another aspect, the local sensors can include one or more positioning systems that can obtain reference information from external sources that allow for various levels of accuracy in determining positioning information for a vehicle. For example, the positioning systems can include various hardware and software components for processing information from GPS sources, Wireless Local Area Networks (WLAN) access point information sources, Bluetooth information sources, radio-frequency identification (RFID) sources, and the like. In some embodiments, the positioning systems can obtain combinations of information from multiple sources. Illustratively, the positioning systems can obtain information from various input sources and determine positioning information for a vehicle, specifically elevation at a current location. In other embodiments, the positioning systems can also determine travel-related operational parameters, such as direction of travel, velocity, acceleration, and the like. The positioning system may be configured as part of a vehicle for multiple purposes, including self-driving applications, enhanced driving or user-assisted navigation, and the like. Illustratively, the positioning systems can include processing components and data that facilitate the identification of various vehicle parameters or process information.

In still another aspect, the local sensors can include one or more navigations system for identifying navigation related information. Illustratively, the navigation systems can obtain positioning information from positioning systems and identify characteristics or information about the identified location, such as elevation, road grade, etc. The navigation systems can also identify suggested or intended lane locations in a multi-lane road based on directions that are being provided or anticipated for a vehicle user. Similar to the location systems, the navigation system may be configured as part of a vehicle for multiple purposes, including self-driving applications, enhanced driving or user-assisted navigation, and the like. The navigation systems may be combined or integrated with positioning systems. Illustratively, the positioning systems can include processing components and data that facilitate the identification of various vehicle parameters or process information.

The local resources further include one or more processing component(s) that may be hosted on the vehicle or a computing device accessible by a vehicle (e.g., a mobile computing device). The processing component(s) can illustratively access inputs from various local sensors or sensor systems and process the inputted data as described herein. For purposes of the present application, the processing component(s) will be described with regard to one or more functions related to illustrative aspects. For example, processing component(s) in vehicles 104 will collect and transmit the first and second datasets.

The environment can further include various additional sensor components or sensing systems operable to provide information regarding various operational parameters for use in accordance with one or more of the operational states. The environment can further include one or more control components for processing outputs, such as transmission of data through a communications output, generation of data in memory, transmission of outputs to other processing components, and the like.

FIG. 2B is a block diagram illustrating an example of vision system 200 included in the autonomous vehicle 102, which includes a multitude of image sensors 202A-202F and an example of processor system 208. The image sensors 202A-202F may include cameras which are positioned about the vehicle 102. For example, the cameras may allow for a substantially 360-degree view around the vehicle 102. Even though the vehicle 102 is described to illustrate the examples as will be described with respect to FIGS. 1 and 2A, the vehicles 104 can also include all or part of the components and/or functionality described in the examples.

The image sensors 202A-202F may obtain images which are used by the processor system 208 to, at least, determine information associated with objects positioned proximate to the vehicle 102. The images may be obtained at a particular frequency, such as 30 Hz, 36 Hz, 60 Hz, 65 Hz, and so on. In some embodiments, certain image sensors may obtain images more rapidly than other image sensors. As will be described below, these images may be processed by the processor system 208 based on the vision-based machine learning model described herein.

Image sensor A 202A may be positioned in a camera housing near the top of the windshield of the vehicle 102. For example, the image sensor A 202A may provide a forward view of a real-world environment in which the vehicle is driving. In the illustrated embodiment, image sensor A 202A includes three image sensors which are laterally offset from each other. For example, the camera housing may include three image sensors which point forward. In this example, a first of the image sensors may have a wide-angled (e.g., fish-eye) lens. A second of the image sensors may have a normal or standard lens (e.g., 35 mm equivalent focal length, 50 mm equivalent, and so on). A third of the image sensors may have a zoom or narrow-view lens. In this way, three images of varying focal lengths may be obtained in the forward direction by the vehicle 102.

Image sensor B 202B may be rear-facing and positioned on the left side of the vehicle 102. For example, image sensor B 202B may be placed on a portion of the fender of the vehicle 102. Similarly, Image sensor C 202C may be rear-facing and positioned on the right side of the vehicle 102. For example, image sensor C 202C may be placed on a portion of the fender of the vehicle 102.

Image sensor D 202D may be positioned on a door pillar of the vehicle 102 on the left side. This image sensor 202D may, in some embodiments, be angled such that it points downward and, at least in part, forward. In some embodiments, the image sensor 202D may be angled such that it points downward and, at least in part, rearward. Similarly, image sensor E 202E may be positioned on a door pillow of the vehicle 102 on the right side. As described above, image sensor E 202E may be angled such that it points downwards and either forward or rearward in part.

Image sensor F 202F may be positioned such that it points behind the vehicle 102 and obtains images in the rear direction of the vehicle 102 (e.g., assuming the vehicle 102 is moving forward). In some embodiments, image sensor F 202F may be placed above a license plate of the vehicle 102.

While the illustrated embodiments include image sensors 202A-202F, as may be appreciated additional, or fewer, image sensors may be used and fall within the techniques described herein.

The processor system 208 may obtain images from the image sensors 202A-202F and detect objects, and signals associated with the objects, using the vision-based machine learning model described herein. Based on the objects, the processor system 208 may adjust one or more driving characteristics or features. For example, the processor system 208 may cause the vehicle 102 to turn, slow down, brake, speed up, and so on. While not described herein, as may be appreciated, the processor system 208 may execute one or more planning and/or navigation engines or models which use output from the vision-based machine learning model to effectuate autonomous driving.

In some embodiments, the processor system 208 may include one or more matrix processors which are configured to rapidly process information associated with machine learning models. The processor system 208 may be used, in some embodiments, to perform convolutions associated with forward passes through a convolutional neural network. For example, input data and weight data may be convolved. The processor system 208 may include a multitude of multiply-accumulate units which perform the convolutions. As an example, the matrix processor may use input and weight data which has been organized or formatted to facilitate larger convolution operations.

For example, input data may be in the form of a three-dimensional matrix or tensor (e.g., two-dimensional data across multiple input channels). In this example, the output data may be across multiple output channels. The processor system 208 may thus process larger input data by merging, or flattening, each two-dimensional output channel into a vector such that the entire, or a substantial portion thereof, channel may be processed by the processor system 208. As another example, data may be efficiently re-used such that weight data may be shared across convolutions. With respect to an output channel, the weight data may represent weight data (e.g., kernels) used to compute that output channel.

FIG. 2C is a block diagram illustrating the example processor system 208 determining object/signal information 234 based on received image information 232 from the example image sensors.

The image information 232 includes images from image sensors positioned about a vehicle (e.g., vehicle 102). In the illustrated example of FIG. 2B, there are 8 image sensors and thus 8 images are represented in FIG. 2C. For example, a top row of the image information 232 includes three images from the forward-facing image sensors. As described above, the image information 232 may be received at a particular frequency such that the illustrated images represent a particular timestamp of images. In some embodiments, the image information 232 may represent high dynamic range (HDR) images. For example, different exposures may be combined to form the HDR images. As another example, the images from the image sensors may be pre-processed to convert them into HDR images (e.g., using a machine learning model).

In some embodiments, each image sensor may obtain multiple exposures each with a different shutter speed or integration time. For example, the different integration times may be greater than a threshold time difference apart. In this example, there may be three integration times which are, in some embodiments, about an order of magnitude apart in time. The processor system 208, or a different processor, may select one of the exposures based on measures of clipping associated with images. In some embodiments, the processor system 208, or a different processor may form an image based on a combination of the multiple exposures. For example, each pixel of the formed image may be selected from one of the multiple exposures based on the pixel, not including values (e.g., red, green, blue) values which are clipped (e.g., exceed a threshold pixel value).

The processor system 208 may execute a vision-based machine learning model engine 236 to process the image information 232. As described herein, the vision-based machine learning model may combine information included in the images. For example, each image may be provided to a particular backbone network. In some embodiments, the backbone networks may represent convolutional neural networks. Outputs of these backbone networks may then, in some embodiments, be combined (e.g., formed into a tensor) or may be provided as separate tensors to one or more further portions of the model. In some embodiments, an attention network (e.g., cross-attention) may receive the combination or may receive input tensors associated with each image sensor.

In some embodiments, the vehicles 104 can include the image sensors 202 and processor system 208 and further include additional detecting components, such as radar, sonar sensor, lidar, etc. In these embodiments, the processor system 208 can also receive data from these additional detecting components and process these data. For example, the processor system 208 may process the image data and the additional data to include timestamp on the data. Further, in this example, each image captured by the image sensors 202 can be processed to include timestamp on each images. Furthermore, the additional data, such as the objects detected by the radar, can be processed to include the timestamp associated with the detected time.

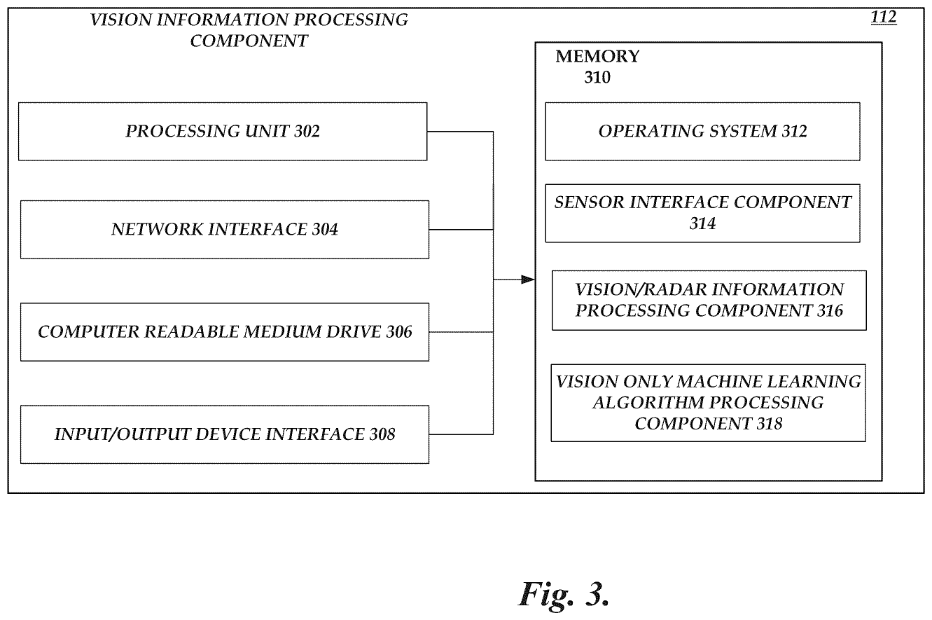

With reference now to FIG. 3, an illustrative architecture for implementing the vision information processing component 112 on one or more local resources or a network service will be described. The vision information processing component 112 may be part of components/systems that provide functionality associated with the operation of headlight components, suspension components, etc. In other embodiments, the vision information processing component 112 may be a stand-alone application that interacts with other components, such as local sensors or sensor systems, signal interfaces, etc.

The architecture of FIG. 3 is illustrative in nature and should not be construed as requiring any specific hardware or software configuration for the vision information processing component 112. The general architecture of the vision information processing component 112 depicted in FIG. 3 includes an arrangement of computer hardware and software components that may be used to implement aspects of the present disclosure. As illustrated, the vision information processing component 112 includes a processing unit, a network interface, a computer readable medium drive, and an input/output device interface, all of which may communicate with one another by way of a communication bus. The components of the vision information processing component 112 may be physical hardware components or implemented in a virtualized environment.

The network interface may provide connectivity to one or more networks or computing systems, such as the network of FIG. 1. The processing unit may thus receive information and instructions from other computing systems or services via a network. The processing unit may also communicate to and from memory and further provide output information for an optional display via the input/output device interface. In some embodiments, the vehicle pitch processing component may include more (or fewer) components than those shown in FIG. 3, such as implemented in a mobile device or vehicle.

The memory 310 may include computer program instructions that the processing unit 302 executes in order to implement one or more embodiments. The memory 310 generally includes RAM, ROM, or other persistent or non-transitory memory. The memory 310 may store an operating system 312 that provides computer program instructions for use by the processing unit in the general administration and operation of the vision information processing component 112. The memory 310 may further include computer program instructions and other information for implementing aspects of the present disclosure. For example, in one embodiment, the memory includes a sensor interface component 314 that obtains information from vehicles, such as vehicles 102/104, data stores, other services, and the like.

The memory 310 further includes a vision/radar information processing component 316 for obtaining and processing the first and second datasets in accordance with various operational states of the vehicle as described herein. In some embodiments, the first dataset is received from vehicles 102/104 and generated from vision only system (e.g., image sensors and processor system 208). In some embodiments, the second dataset can include additional datasets received from additional components other than the vision system. These other components can include, for example, radar, lidar, sonar sensor, etc. The second dataset can represent the moving characteristics of objects, such as moving direction, velocity, acceleration, etc.

The memory 310 can further include a vision only machine learning model processing component 318 for utilizing a combined dataset to generate machine learning model for use in vision-only based vehicles 102. Although illustrated as components combined within the vision information processing component 112, one skilled in the relevant art will understand that one or more of the components in memory may be implemented in individualized computing environments, including both physical and virtualized computing environments. In some embodiments, the vision only machine learning model processing component 318 can label each object included in the images of the first dataset. In some embodiments, the vision only machine learning model processing component 318 may identify the objects by using ground truth data. For example, a vehicle can have its own ground truth label, and the vehicles included in the first dataset and/or the second dataset can be labeled with the ground truth label associated with the vehicle. In some embodiments, the vision only machine learning model processing component 318 may identify timestamp of each data of the first and second datasets. For example, image data included in the datasets may include timestamp that represent the captured time. Further in this example, the additional data generated from the additional components and included in the second dataset can have timestamp that represent the detection time.

In some embodiments, the vision only machine learning model processing component 318 may combine the first and second datasets based on the timestamp. For example, the additional component may determine the velocity of a vehicle by sensing the vehicle, and the vision only machine learning model processing component 318 may determine the images of the vehicle that has the same timestamp with the sensed time. In some embodiments, the vision only machine learning model processing component 318 overlays the second dataset to the corresponding first dataset based on the timestamp. For example, a moving vehicle included in the first dataset can be labeled with the supplemental information, such as velocity, direction, or acceleration information included in the second dataset.

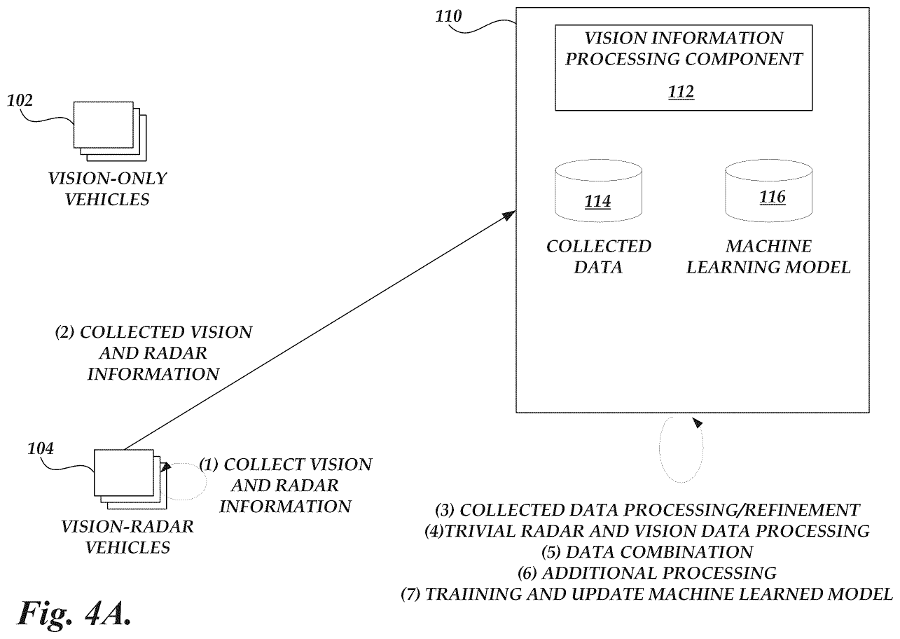

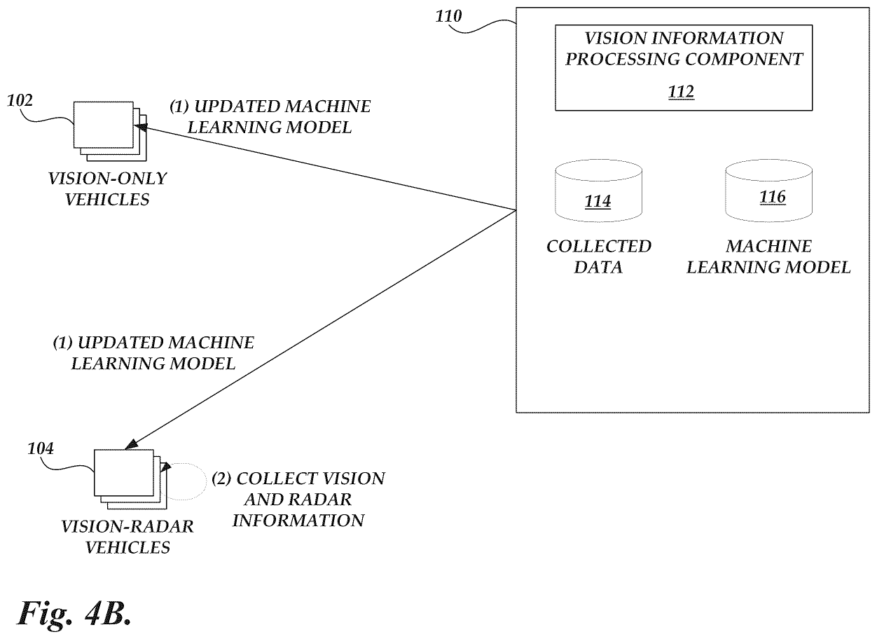

Turning now to FIGS. 4A and 4B, illustrative interactions for the components of the environment to generate and processing vision and detection system data to update training models for machine learning models will be describe. With reference to FIG. 4A, at (1), one more target vehicles 104 can collect and transmit a set of inputs (e.g., the first dataset and the second dataset). As described above, the target vehicle(s) 104 includes both vision and detection systems. The first set of data illustratively corresponds to the video image data and any associated metadata or other attributes collected by the vision system 200 of the target vehicle 104. Illustratively, the vision system may run as a parallel process, generally referred to as a shadow mode, which allows for the processing of data using a vision system 200 to form the first set of data. Such parallel process, or shadow mode, can be illustratively implemented so as to be executed in a secondary mode that is not otherwise used for operational information for the target vehicle(s) 104. Such an instance may be completely isolated from other detection systems (e.g., a radar-based detection system) so as to not interfere with the operation of the other detection systems. Additionally, the second set of data illustratively corresponds to detection system data (e.g., radar data, LIDAR data, etc.) and associated detected attributes. Both the first and second sets of time correspond to time-based data that allows for comparison of detected objects and attributes along common time frameworks.

At (2), the set of target vehicles 104 can collect vision and radar information and provide the collected data. The target vehicles 104 may transmit synchronously or asynchronously based on time or event criteria. Additionally, the set of target vehicles 104 may batch the collected first and second datasets.

At (3), the vision information processing component 112 can then process and/or perform refinement on the collected data. For example, the vision information processing component 112 may process the vision-based data, such as to complete lost frames of video data, update version information, error correction, and the like. At (4), the vision information processing component 112 then generates a trivial version of the first set of data (e.g., vision data) and the second set of data (e.g., detection data) that standardizes the data for use in the machine learning model 116. For example, the vision information processing component 112 can utilize the machine learning model 116 to process the collected first set of data (e.g., vision data) to illustratively generate representations of detected objects in the form of bounding boxes and three-dimensional positions. In another example, the vision information processing component 112 can utilize the collected set of second data (e.g., detection system data) to identify a set number of attributes (e.g., position and velocity) for each detected object.

At (5), the vision information processing component 112 then combines the data based on standardized data. Illustratively, the combined datasets allow the supplementing of the previously collected vision data with additional information or attribute/characteristics that may not have been otherwise available from processing the vision data. The combined set of data can result in a set of data that tracks objects of a defined set of time based on the first and second sets of data. As described previously, using the combined data as training data, updated or enhanced machine learning model (e.g., a neural network) can be generated to utilize solely information from vision system as the detection method/system. As described above, the vision information processing component 112 can automatically create larger amounts of trained data based on utilizing the attribute information obtained from the non-video-based detection system as label data for the corresponding, respective video-based detection system. This not only increases the speed of the creation of the training data but can result in much larger training sets for improved machine learning model performance. Additionally, the resulting accuracy of the video-based detection models can be improved because of the details that can verified by the non-video-based detection systems.

At (6), the vision information processing component 112 can then process the combined dataset using various techniques. Such techniques can include smoothing, extrapolation of missing information, applying kinetic models, applying confidence values, and the like. At (7), the vision information processing component 112 generates an updated machine learning model based on training on the combined dataset. Illustratively, the vision information processing component 112 can utilize a variety of machine learning models to generate updated machine learning model.

With reference to FIG. 4B, the vision information processing component 112 can then utilize the updated machine learning model 116 in a variety of manners. In one aspect, at (1), the vision information processing component 112 can transmit the updated model to vision-only based vehicles 102 for processing in an operational manner. In another aspect, at (1), the vision information processing component 112 can transmit to target vehicles 104 with both vision and detection systems for repeating the process and further updating/refining the machine learning model at (2). Thus, the interaction and processing may be repeated and continuous.

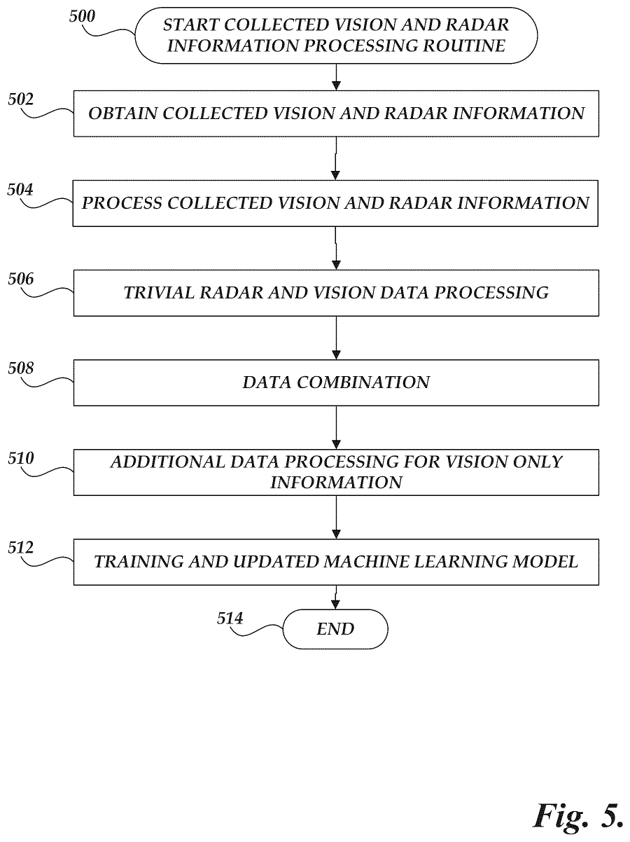

Turning now to FIG. 5, a routine 500 for processing collected vision and detection system data will be described. Routine 500 is illustratively implemented by the vision information processing component 112 included in the network service 110. As described above, routine 500 may be implemented after the target vehicle(s) 104, including both vision and detection systems, have provided the first and second sets of data. The first set of data illustratively corresponds to the video image data and any associated metadata or other attributes collected by the vision system 200 of the target vehicle 104. Illustratively, the vision system may run as a parallel process, generally referred to as a shadow mode, which allows for the processing of data using a vision system 200 to form the first set of data. Additionally, the second set of data illustratively corresponds to detection system data (e.g., radar data, LIDAR data, etc.) and associated detected attributes. Both the first and second set of time correspond to time-based data that allows for comparison of detected objects and attributes along common time frameworks.

At block 502, the vision information processing component 112 obtains collected vision and radar information from a set of target vehicles 102/104. In some embodiments, the set of target vehicles 104 can provide the collected data. The target vehicles 102/104 may transmit synchronously or asynchronously based on time or event criteria. Additionally, the set of target vehicles 102/104 may batch the collected set of data.

At block 504, the vision information processing component 112 can then process the collected vision-based data, such as to complete lost frames of video data, update version information, error correction, and the like, and radar information.

At block 506, the vision information processing component 112 then generates trivial version of the first set of data (e.g., vision data) and the second set of data (e.g., detection data) that standardizes the data for use in machine learning model. For example, the network service can utilize machine learning model to process the collected first set of data (e.g., vision data) to illustratively generate representations of detected objects in the form of bounding boxes and three-dimensional positions. In another example, the network service can utilize the collected set of second data (e.g., detection system data) to identify a set number of attributes (e.g., position and velocity) for each detected object.

At block 508, the vision information processing component 112 then combines the data based on standardized data. Illustratively, the combined datasets allow the supplementing of the previously collected vision data with additional information or attribute/characteristics that may not have been otherwise available from processing the vision data. The combined datasets can result in a set of data that tracks objects of a defined set of time based on the first and second sets of data. More specifically, the information from the other detection system (e.g., a radar-based system) can either confirm the information from the vision system, correct information from the vision system or otherwise supplement information collected from the vision system. In turn, the resulting trained machine learning model(s) trained from the combined datasets can be optimized to account for errors or inefficiencies that would have otherwise been generated from vision only data.

In some embodiments, the vision information processing component 112 combines the datasets-based label and timestamp of each data of the datasets. In some embodiments, the vision information processing component 112 can label each object included in the images of the first dataset. In some embodiments, the vision information processing component 112 may identify the objects by using ground truth data. For example, a vehicle can have its own ground truth label, and the vehicles included in the first dataset and/or the second dataset can be labeled with the ground truth label associated with the vehicle. In some embodiments, the vision information processing component 112 may identify timestamp of each data of the first and second dataset. For example, image data included in the datasets may include timestamp that represents the captured time. Further, in this example, the additional data generated from the additional components and included in the second dataset can have timestamp that represents the detection time.

In some embodiments, the vision information processing component 112 may combine the first and second datasets based on the timestamp. For example, the additional component may determine the velocity of a vehicle by sensing the vehicle, and the vision information processing component 112 may determine the images of the vehicle that has the same timestamp with the sensed time. In some embodiments, the vision information processing component 112 overlays the second dataset to the corresponding first dataset based on the timestamp. For example, a moving vehicle included in the first dataset can be labeled with the supplemental information, such as velocity, direction, or acceleration information included in the second dataset.

At block 510, the vision information processing component 112 can then process the combined dataset using various techniques. Such techniques can include smoothing, extrapolation of missing information, applying kinetic models, applying confidence values, and the like. At block 512, the vision information processing component 112 generates an updated machine learning model based on training on the combined dataset. Illustratively, the vision information processing component 112 can utilize a variety of machine learning models to generate updated machine learning model. Routine 500 terminates at block 514.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims. Although not discussed in detail in the present application, one or more aspects of the present application may be combined or incorporated together with regard to further improving the formation of training data or improving the operation of vision-only-based detection systems.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed decision and control models. It is to be understood that the forms of disclosure herein shown and described are to be taken as representative embodiments. Equivalent elements, materials, processes, or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer those two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

What is claimed:

1. A method for determining configured vision-only systems comprising:
obtaining a set of data corresponding to operation of a vehicle, wherein the set of data includes a first set of data corresponding to operation of a vision-based detection system and a second set of data corresponding to operation of a non-vision-based detection system, wherein the first and second sets of data correspond to a common timestamp;
processing the first set of data to correspond to a common format for detection;
processing the second set of data to correspond to the common format for detection;
combining the processed first set of data and the processed second set of data to form a common set of data;
processing the combined set of data; and
training a machine learning model for vision-based detection system based on the processing combined set of data.

2. The method of claim 1, wherein the second set of data corresponds to characterization of moving objects, and wherein the characterization includes at least one of velocity, acceleration, or direction of the moving objects.

3. The method of claim 1, wherein each set of combined first and second sets of data has the common timestamp.

4. The method of claim 1, wherein processing the first set of data includes generating representations of detected objects included in the first set of data via bounding boxes and three-dimensional positions.

5. The method of claim 1, wherein processing the second set of data includes identifying a set number of attributes for each detected object.

6. The method of claim 1, wherein processing the combined set of data uses at least one of smoothing, extrapolation of missing information, applying kinetic models, and applying confidence values technique.

7. The method of claim 1, wherein the trained machine learning model is transmitted to the vehicle.

8. A system comprising one or more processors and non-transitory computer storage media storing instructions that when executed by the one or more processors, cause the processors to generate a set of machine learning model training data, wherein the system is included in a network service, and wherein the generation of the training data comprises:
obtaining a set of data corresponding to operation of a vehicle, wherein the set of data includes a first set of data corresponding to operation of a vision-based detection system and a second set of data corresponding to operation of a non-vision-based detection system, wherein the first and second sets of data correspond to a common timestamp;
processing the first set of data to correspond to a common format for detection;
processing the second set of data to correspond to the common format for detection;
combining the processed first set of data and the processed second set of data to form a common set of data;
processing the combined set of data; and
training a machine learning model for vision-based detection system based on the processing combined set of data.

9. The system of claim 8, wherein the second set of data corresponds to characterization of moving objects, and wherein the characterization includes at least one of velocity, acceleration, or direction of the moving objects.

10. The system of claim 8, wherein each set of combined first and second sets of data has the common timestamp.

11. The system of claim 8, wherein processing the first set of data includes generating representations of detected objects included in the first set of data in a form of bounding boxes and three-dimensional position.

12. The system of claim 8, wherein processing the second set of data includes identifying a set number of attributes for each detected object.

13. The system of claim 8, wherein processing the combined set of data uses at least one of smoothing, extrapolation of missing information, applying kinetic models, and applying confidence values technique.

14. The system of claim 8, wherein the trained machine learning model is transmitted to the vehicle.

15. Non-transitory computer storage media storing instructions that when executed by a system of one or more processors which are included in an autonomous or semi-autonomous vehicle, cause the system to perform operations comprising:
obtaining a set of data corresponding to operation of a vehicle, wherein the set of data includes a first set of data corresponding to operation of a vision-based detection system anda second set of data corresponding to operation of a non-vision-based detection system, wherein the first and second sets of data correspond to a common timestamp;
processing the first set of data to correspond to a common format for detection;
processing the second set of data to correspond to the common format for detection;
combining the processed first set of data and the processed second set of data to form a common set of data;
processing the combined set of data; and
training a machine learning model for vision-based detection system based on the processing combined set of data.

16. The computer storage media of claim 15, wherein the second set of data corresponds to characterization of moving objects, and wherein the characterization includes at least one of velocity, acceleration, or direction of the moving objects.

17. The computer storage media of claim 15, wherein each set of combined first and second sets of data has the common timestamp.

18. The computer storage media of claim 15, wherein processing the first set of data includes generating representations of detected objects included in the first set of data in a form of bounding boxes and three-dimensional position.

19. The computer storage media of claim 15, wherein processing the second set of data includes identifying a set number of attributes for each detected object.

20. The computer storage media of claim 15, wherein processing the combined set of data uses at least one of smoothing, extrapolation of missing information, applying kinetic models, applying confidence values technique.
